(19) United States
(12) Patent Application Publication
(10) Pub. No.: US 2011/0257853 A1
(43) Pub. Date: Oct. 20, 2011

(54) DRIVER ASSISTANCE SYSTEM AND METHOD FOR ADJUSTING A DRIVER ASSISTANCE SYSTEM

(76) Inventors: Joerg Zeller, Stuttgart (DE); David Rubia Serrano, Ludwigsburg (DE); Lars Kaiser, Markgroeningen (DE)

(21) Appl. No.: 13/089,810

(22) Filed: Apr. 19, 2011

(30) Foreign Application Priority Data
Apr. 20, 2010 (DE) 102010027978.1

(51) Int. Cl. B60W 30/02; B60W 10/18; B60W 10/12

(52) U.S. Cl. 701/53

(57) ABSTRACT

A driver assistance system has braking devices at the wheels of a driven vehicle axle as well as an active locking differential. In a regulation or control unit, braking or locking torques are determined, a distribution module being connected downstream from the regulation or control unit, in which module actuating signals can be produced in order to control the braking devices and the locking differential.

### BACKGROUND INFORMATION

German Patent Application No. DE 10 2006 031 511 describes automatically intervening in a wheel brake via a vehicle controller in order to stabilize a vehicle in a potentially dangerous dynamic driving situation. Here, an additional torque is produced at at least one wheel that results in a yawing moment about the vehicle vertical axis, achieving or supporting the stabilizing effect. The controlling of the wheel brakes takes place with the aid of a vehicle regulation system such as an electronic stability program (ESP).

In addition, it is known to use locking differentials or torque vectoring systems to carry out a distribution of torques at the left and right wheels of a vehicle axle. If locking differentials are used, rotational speed differences between the wheels can be compensated, while torque vectoring systems enable an active distribution of drive torques between the left and right wheels.

The controlling of such driver assistance systems takes place via regulating or control devices. In order to prevent contradictory requirements coming from different driver assistance systems, the regulation or control device of a locking differential is controlled, for example via the electronic stability program that actuates the wheel braking devices, whereupon actuating signals are generated in the regulating or control device of the locking differential in order to produce a locking torque. The electronic stability program thus acts as a switch for switching the locking differential function on and off.

### SUMMARY OF THE INVENTION

The present invention is based on the object of providing an improved and simplified linkage between the braking devices in a vehicle and an active locking differential between two driven wheels of a vehicle axle.

The driver assistance system according to the present invention includes on the one hand braking devices for producing braking torques at the wheels of a vehicle axle, and on the other hand includes an active locking differential between two driven wheels of the same axle, at which the braking torques also act. In the locking differential, a locking torque can be set in order to minimize or completely eliminate differences in rotational speed between the wheels of the axle. The active locking differential should expressly include not only systems for compensating rotational speed differences, but also torque vectoring actuators via which an active distribution of drive torques between the left and right wheel of an axle is possible.

Furthermore, a regulating or control unit is allocated to the driver assistance system, in which a distribution of torque between the wheels of the axle is determined as a function of current vehicle state and operating quantities. The torque distribution is supplied as an input signal to a distribution module that is connected downstream from the regulating or control unit, and in which actuating signals are produced for controlling both the braking devices and the locking differential.

This configuration has the advantage that a distribution of torque between the left and right wheel of a driven axle can be produced using a common regulating or control unit. The regulating or control unit preferably contains a regulator, for example a PI regulator, via which the distribution of torques is calculated in a closed loop as a function of currently determined vehicle state quantities.

In principle, in the driver assistance system according to the present invention it is sufficient to provide only one regulator, whereas in embodiments from the prior art a respective regulator is required both for the controlling of the braking devices and for the controlling of the active locking differential. Thus, the realization according to the present invention saves a regulator. The specific distribution of torques via the locking differential and/or via the braking devices takes place via the distribution module connected downstream from the regulation or control unit that has the regulator realized therein. This module itself does not have its own regulator, but rather merely accomplishes the distribution, according to prespecified criteria, of the torques between the locking differential and the braking devices. The criteria or conditions according to which the distribution of the torques takes place are in principle merely supplied to the distribution module or are stored in this module, so that the regulation or control unit does not necessarily have to be included in the provision of the criteria or conditions. This has the advantage that known regulators can be used in the regulation or control unit with no modification or with only slight modification. Thus, it is in particular possible to use a regulation or control unit from a driver assistance system via which a controlling of the braking devices is possible, for example an electronic stability program ESP, an anti-lock braking system ABS, or an anti-slip regulator ASR, to the extent that these can control the braking devices. In principle, such regulators are used to determine or specify a braking torque distribution. In the driver assistance system according to the present invention, via the downstream-connected distribution module, from the distribution of braking torques a general distribution of torques can be used to produce locking torques in the active locking differential and/or to produce braking torques in the braking devices.

The additional module is preferably realized without its own regulator. It is useful to provide vehicle state quantities to the additional module as input information that is taken into account in the distribution of the torques between the locking differential and the braking devices. The current vehicle state quantities that are supplied to the distribution module, either immediately via data lines in the vehicle or via the higher-level regulation or control unit, can be taken into account in the criteria or conditions on which the distribution of torques is based.

According to another useful embodiment, it is provided that at least one separately fashioned supplementary unit communicates with the distribution module and supplies input signals to the distribution module, further conditions for the distribution of torques being storable in the supplementary unit. Via this structure, it is possible to connect a multiplicity of such supplementary units to the distribution module, criteria for the distribution of torques being formulable in each of the supplementary units. Thus, it is for example possible, in accordance with current driving conditions, to specify a maximum possible locking torque in the locking differential, so that this differential is completely locked and the same, maximum possible, drive torque acts at both wheels. When driving in a straight path, and given appropriately favorable weather and street conditions, this procedure can be useful for a maximum possible acceleration.

A further aspect of the present invention relates to a method for adjusting a driver assistance system that is equipped with a common regulation or control unit for producing signals for the distribution of torques between the braking devices at the wheels of a vehicle axle, and with an active locking differential of the same axle. In the regulation or control unit, the generation of the distribution of torques takes place as described above, realized according to one or more defined criteria by the production of a locking torque in the locking differential and/or by the production of braking torques at the vehicle wheels. Here, it is advantageous to carry out the distribution of torques preferably via the locking torque in the locking differential, and only in supplementary fashion via braking torques, because, in contrast to the braking devices, only minimal energy, or no energy, is dissipated in the locking differential. Thus, the distribution of torques is carried out as far as possible via the locking differential, and only in supplementary fashion via the braking devices, in particular for the case in which the desired distribution of torques cannot be accomplished exclusively via the locking differential. In addition, it can be useful, for example in order to brake the driven vehicle axle, to apply a braking torque to one or to both vehicle wheels, in addition to the locking torque in the locking differential.

Via the driver assistance system, an intervention in the engine management of the vehicle engine is also usefully possible. Here, the engine torque emitted by the engine is adjusted, which takes place in a manner that is coordinated with the actuation of the locking differential and of the braking devices. For example, in some driving situations it is useful to reduce the drive torque, in particular if traction is reduced; in such situations, in addition to the drive torque reduction an application of a braking torque may also be useful, because the intervention in the drive engine takes effect more slowly, due to the inertia of the engine, than does the intervention via the braking device.

In the realization of the regulation or control unit as a component of an electronic stability program ESP, it is useful to keep the ESP hydraulic pump, via which the braking devices are supplied with brake pressure, permanently in operation in order to avoid continual switching on and off of the pump. Here, the ESP hydraulic pump is operated in particular with a lower rotational speed, i.e. a smaller pumping capacity, and is preferably operated exclusively during active regulation in the regulation or control unit.

In sum, using the device or method according to the present invention a driver assistance system that includes braking devices as well as an active locking differential at a driven axle can be operated in such a way that it is possible, using only one regulator in a common regulation or control unit, to achieve a distribution of torques between the left and right wheels of an axle both by controlling the active locking differential and by controlling the braking devices at these wheels. The distribution of the torque between the locking differential on the one hand and the braking devices at the wheels of the same axle on the other hand takes place via a distribution module connected downstream from the regulation or control device, said module either being a separate constructive unit that communicates with the regulation or control device, or being connected to the regulation or control device or fashioned in one piece therewith. The distribution module itself does not have a regulator; however, current state and operating quantities are supplied to the distribution module that are taken into account in making the decision concerning which actuating device is used to produce torque. Through the modular structure, it is possible to connect additional subsystems or subunits that communicate with the distribution module and via which additional conditions can be specified that influence the distribution of torque between the locking differential and the braking devices.

### BRIEF DESCRIPTION OF THE DRAWING

FIG. 1 shows a schematic diagram that includes a driver assistance system in a vehicle having an active locking differential and braking devices.

### DETAILED DESCRIPTION

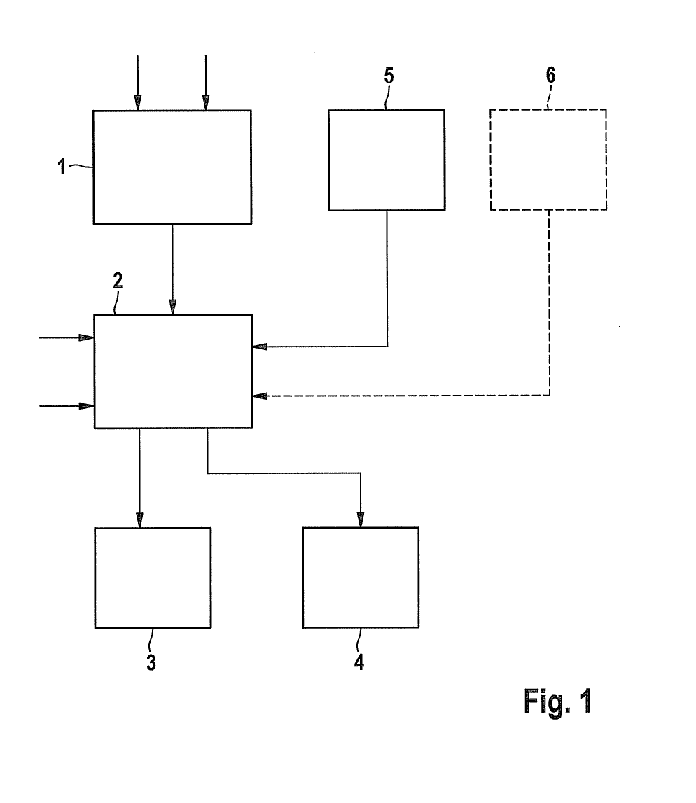

FIG. 1 shows a driver assistance system having an electronic stability program (ESP) 1 that includes a regulation or control unit containing a regulator, and via which, as a function of current state or operating quantities of the vehicle and of the aggregates allocated to the vehicle, an actuating signal is produced that is supplied as an input quantity to a distribution module 2 connected downstream. The input quantity supplied to distribution model 2 by ESP system 1 represents a distribution of torques between the torques at the driven wheels of a vehicle axle, the torques being partitioned between the two wheels either via an active locking differential in the axle and/or via a braking intervention at the two braking devices at the left and right vehicle wheel of the same axle. Distribution module 2 takes over the distribution of the torque to locking differential 3 and to braking devices 4 as a function of defined criteria that are either stored in the distribution module or are supplied to it. In addition, as input quantities distribution module 2 is supplied with vehicle state and operating quantities, as well as information about the surrounding environment if warranted, the distribution of torque to the braking devices and to the locking differential also being carried out as a function of these quantities. Braking devices 4 include the two braking systems at the left and right wheel of a common driven vehicle axle, locking differential 3 also acting between these vehicle wheels.

The vehicle state and operating quantities, as well as the information about the surrounding environment, can also be supplied to distribution module 2 via ESP system 1 if warranted.

In addition, supplementary units 5 and 6 that also communicate with distribution module 2 are allocated to the driver assistance system. Criteria for the distribution are supplied to distribution module 2 via supplementary units 5 and 6, as well as additional supplementary units if warranted. For example, in some operating situations, in order to achieve a maximum possible vehicle acceleration it is useful to shift locking differential 3 into the locked position by applying a high locking torque to it, so that no differences in rotational speed are then possible at the left and right wheel of this axle. In order to achieve such a driving situation with maximum possible acceleration, the maximum possible locking torque is applied to the locking differential.

A regulator is not provided in distribution module 2. The regulation takes place exclusively via ESP system 1.

The drive engine is for example an internal combustion engine, but in addition or alternatively electric drive motors may be used.

Via ESP system 1, advantageously not only is a distribution of torque specified between the left and right wheel of the driven axle, but in addition the drive torque of the drive engine is also influenced.

The active locking differential 2 can compensate rotational speed differences between the left and the right vehicle wheel. In principle, however, active locking differential 2 may also be a torque-vectoring actuator via which drive torques can be actively distributed between the left and right vehicle wheel.

What is claimed is:

1. A driver assistance system having braking devices for producing braking torques at vehicle wheels of a vehicle axle, comprising:
an active locking differential between two driven wheels of the same vehicle axle for producing a braking torque;
a regulation or control device for determining braking or locking torques; and
a distribution module connected downstream from the regulation or control device, the distribution module receiving the braking or locking torques as input quantities, the distribution module providing actuating signals for controlling the braking devices and the locking differential.

2. The driver assistance system according to claim 1, wherein current vehicle state quantities are supplied to the distribution module as input quantities.

3. The driver assistance system according to claim 1, further comprising at least one supplementary unit communicating with the distribution module, input signals being supplied to the distribution module by the supplementary unit, additional conditions for a distribution of torques being stored in the supplementary unit.

4. The driver assistance system according to claim 1, wherein the regulation or control device is a component of an electronic stability program.

5. A method for adjusting a driver assistance system, comprising:
determining braking or locking torques at vehicle wheels of a driven vehicle axle in a regulation or control unit; and
distributing the torques to at least one of (a) an active locking differential and (b) braking devices, according to a defined criterion.

6. The method according to claim 5, wherein the distribution of torques is carried out by producing a locking torque in the locking differential, and is carried out only in supplementary fashion by producing braking torques.

7. The method according to claim 5, further comprising adjusting an engine torque of a drive engine in the vehicle.

8. The method according to claim 5, wherein the regulation or control unit is a component of an electronic stability program, and an electronic stability program hydraulic pump is kept permanently in operation in order to produce braking pressure in the braking devices while the regulation or control unit actively regulates.
